(19) United States
(12) Patent Application Publication
(10) Pub. No.: US 2011/0261519 A1
(43) Pub. Date: Oct. 27, 2011

(54) Electronic Device with Swinging Board

(75) Inventors: Wen-Yi CHIU, Taipei City (TW); Chien-Yuan CHEN, Taipei City (TW); Hong-Tien WANG, Taipei City (TW); You-Chi LIU, Taipei City (TW); Sy-Gia KIONG, Taipei City (TW)

(73) Assignee: COMPAL ELECTRONICS, INC., Taipei City (TW)

(21) Appl. No.: 12/824,518

(22) Filed: Jun. 28, 2010

(30) Foreign Application Priority Data
Apr. 21, 2010 (TW) 99112554

(51) Int. Cl. G06F 1/16; H01R 13/44

(52) U.S. Cl. 361/679.02; 439/131

(57) ABSTRACT

An electronic device with a swinging board is described. The electronic device includes a body, a swinging board and a connector. The body includes a reserving chamber and a circuit board, and the swinging board includes at least one opening. The swinging board is connected to the body and movable between an operating position and a reserving position with respect to the reserving chamber. The connector is disposed in the opening and electrically connecting with the circuit board. The connector is stored in the reserving chamber when the swinging board is rotated to the reserving position. Alternatively, the connector is moved to the outside of the reserving chamber when the swinging board is rotated to the operating position.

### RELATED APPLICATIONS

This application claims priority to Taiwan Application Serial Number 99112554, filed Apr. 21, 2010, which is herein incorporated by reference.

### FIELD OF THE INVENTION

The present invention generally relates to an electronic device. More particularly, this invention relates to an electronic device with a swinging board.

### BACKGROUND OF THE INVENTION

Information technology and the computer industry are highly developed now. Electronic devices, such as a notebook computer, are widely used. Due to weight and practical requirements, electronic devices tend to be lighter, thinner and smaller. The notebook computer is a successful product because the notebook computer with powerful calculation capability deals with a great amount of digital data.

Since the size of the notebook computer is thinner and smaller, various connectors, e.g. universal serial bus connector, network connector and video graphics array connector, are therefore equipped on the sidewall of the notebook computer to connect to various expansion devices for the notebook computer.

Therefore, more and more connectors occupy the sidewall of a thinner and smaller notebook computer. Because the connectors are disposed on the sidewall of the computer, the height of the connector may limit the thickness of the notebook computer. Hence, there is a need to adequately dispose the connectors on the notebook computer at suitable positions to further reduce the thickness of the notebook computer.

### SUMMARY OF THE INVENTION

One objective of the present invention is to provide an electronic device with a swinging board to prevent a height of a connector from limiting a thickness of an electronic device.

To achieve these and other advantages and in accordance with the objective of the present invention, as the embodiment broadly describes herein, the present invention provides an electronic device with a swinging board. The electronic device with the swinging board according to the present invention includes a body, a swinging board and a connector. The body includes a reserving chamber and a circuit board. The swinging board includes an opening. The swinging board is connected to the body and movable between an operating position and a reserving position for the reserving chamber. The connector is disposed in the opening and electrically connected to the circuit board. In addition, the connector is stored in the reserving chamber when the swinging board is rotated to the reserving position. Alternatively, the connector is moved to an outside of the reserving chamber when the swinging board is rotated to the operating position.

A rotating angle of the swinging board between the reserving position and the operating position is preferably greater than 90 degrees. The connector is a RJ-45 connector, a VGA connector or a power connector. A thickness of the connector is smaller than a length of the connector, and a thickness of the connector is also smaller than a height of the connector. The electronic device is a notebook computer, an electronic book, a tablet personal computer, or a netpad.

Hence, an external electronic device can be conveniently attached to the electronic device with the swinging board according to the present invention, and the thickness limitation of the electronic device can be further improved due to eliminate the height restriction of the connector. Therefore, the electronic device with the swinging board according to the present invention can be operated more easily.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a rear view of a pictorial drawing showing an embodiment of an electronic device with a swinging board according to the present invention;

FIG. 2 illustrates a rear view of a pictorial drawing showing that the display panel and the body of the electronic device shown in FIG. 1 are opened;

FIG. 3 illustrates a rear view of a pictorial drawing showing that the electronic device shown in FIG. 1 is in a service condition;

FIG. 4 illustrates a side view of the electronic device shown in FIG. 3;

FIG. 5 illustrates a rear view of the electronic device shown in FIG. 3 showing that cables are disposed on the electronic device;

FIG. 6 illustrates a bottom view of the electronic device shown in FIG. 5;

FIG. 7 illustrates a vertical view of a pictorial drawing showing another embodiment of an electronic device with a swinging board according to the present invention; and

FIG. 8 illustrates the swinging board is opened from the electronic device shown in FIG. 7 to form a foot for the electronic device.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

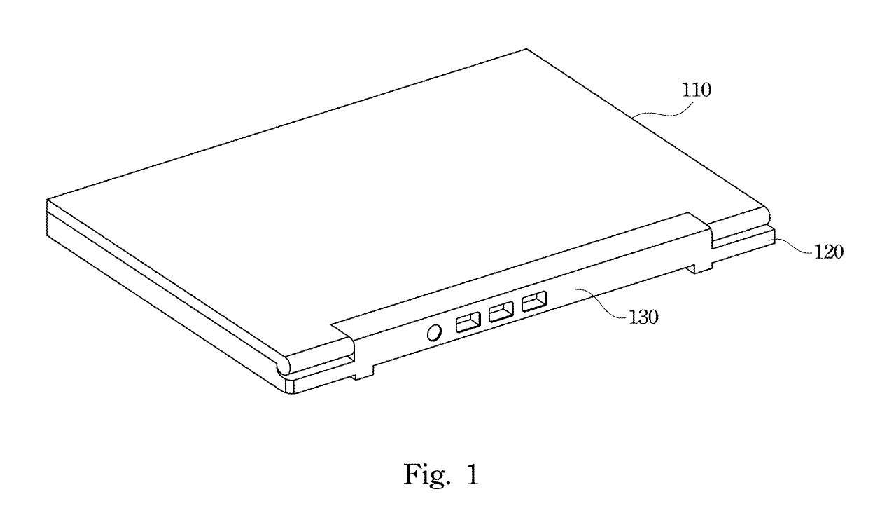

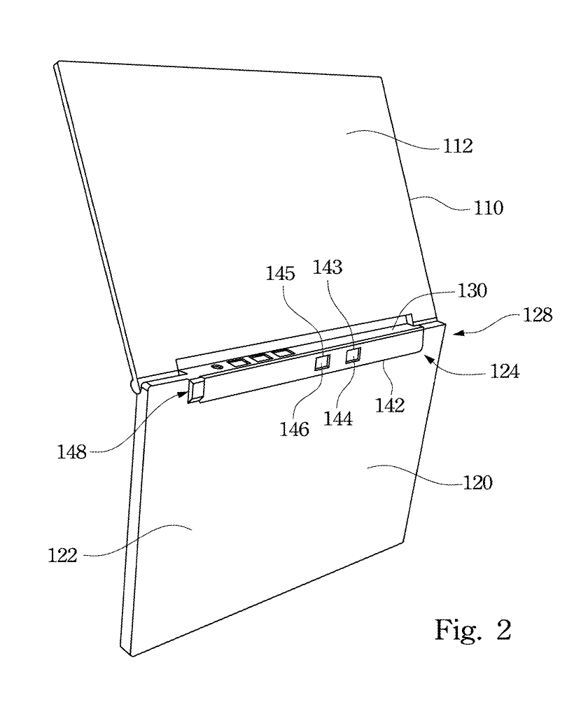

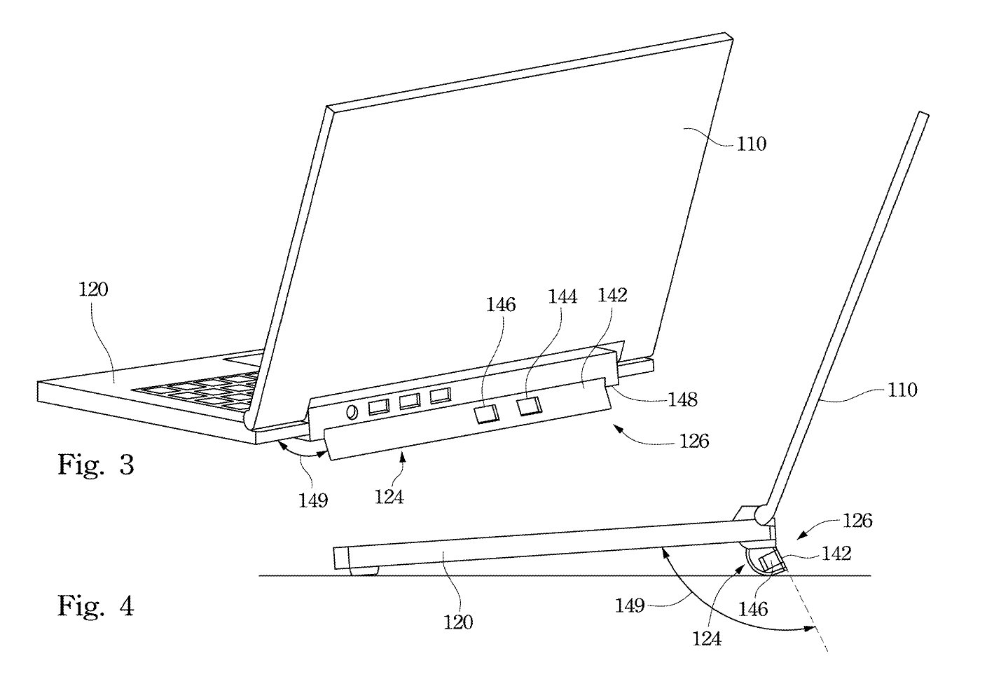

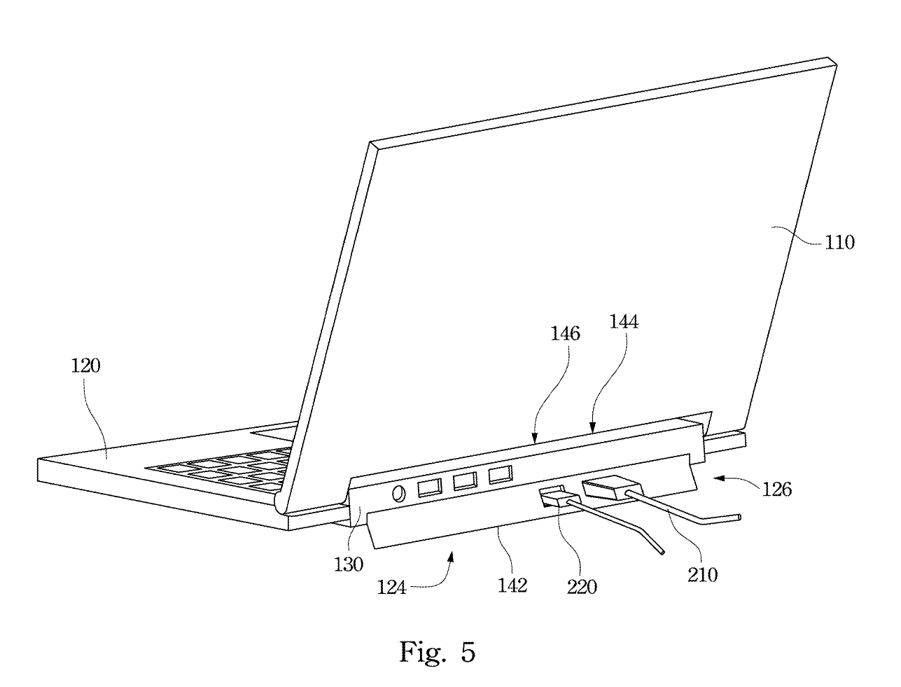

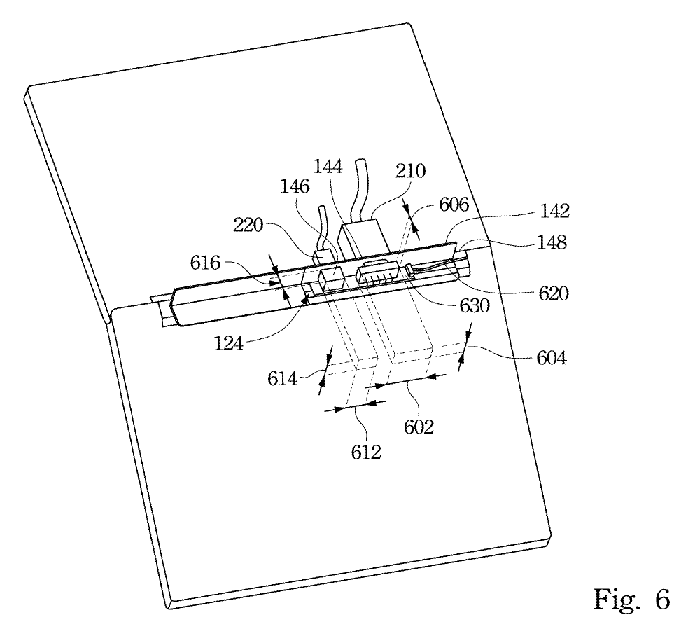

Refer to FIGS. 1-6. FIG. 1 illustrates a rear view of a pictorial drawing showing an embodiment of an electronic device, e.g. a notebook computer, with a swinging board according to the present invention. FIG. 2 illustrates that the display panel of the electronic device is opened from the body of the electronic device. FIG. 3 illustrates the electronic device is in a service condition. FIG. 4 illustrates a side view thereof. FIG. 5 illustrates that the electronic device is equipped with cables. In addition, FIG. 6 illustrates a bottom view of the electronic device shown in FIG. 5.

Notebook computer includes a display panel 110 and a body 120, and a plurality of connectors disposed on a rear surface 130 thereof to connect to external electronic devices. Currently, the connectors are equipped not only on the rear surface but also on the side surface and the front surface for the notebook computers to provide enough connectors to connect to the external electronic devices.

However, since the thickness of the notebook computer is getting thinner and thinner, some higher connectors may limit the thickness of the notebook computer. If the thickness of the notebook computer has to further reduce, some of the connectors have to cancel or an additional external connecting device, e.g. expansion dock, has to connect to the notebook computer. Therefore, the input and output capability of the notebook computer itself is limited without the canceled connectors or the connectors only configured in the expansion dock which is difficult to hand carry.

To further increase the positions to dispose the connectors in the notebook computer without limiting the thickness of the notebook computer, the present invention discloses to use a swinging board 142 able to rotate and store in the lower cover 122 of the body 120 of the notebook computer. When the swinging board 142 is stored in the notebook computer, the swinging board 142 can be rotated to a reserving chamber 124 of the body 120 of the notebook computer. For example, with reference to FIG. 2, the reserving chamber 124 is formed on the lower cover 122 of the body 120 to allow the swinging board 142 being stored in a reserving position 128 so that the connectors can be stored in the reserving chamber 124, and preferably the connectors are toward to the bottom of the notebook computer. When a user needs to use the connectors, the user can rotate the swinging board 142 outward to an operating position 126, see FIGS. 3 and 4. The connectors are therefore exposed to the outside of the reserving chamber 124 of the notebook computer so that the connectors can easily connect to the external electronic devices. The swinging board 142 can further form a foot for the electronic device. In one embodiment, the swinging board 142 can raise the rear surface 130 and the body 120 of the notebook computer to a desired height so that the user can conveniently read on and operate the notebook computer.

The swinging board 142 further includes a hinge 148 and at least one opening, e.g. opening 143 and opening 145, to dispose corresponding connectors therein. In one embodiment, a first connector 144 is disposed in the opening 143, and a second connector 146 is disposed in the opening 145.

When a user wants to use the foregoing connectors, the user can rotate the swinging board 142 outward approximately an angle 149 to the operating position 126 so that the first connector 144 and the second connector 146 are exposed to the outside of the lower cover 122 of the body 120 of the notebook computer. Subsequently, the user can conveniently attach a first cable 210 and a second cable 220 to corresponding connectors. The angle 149 is, for example, greater than 90 degrees to form the foot for the notebook computer and allows the first connector 144 and the second connector 146 being exposed to the outside. The angle 149 can be from 90 degrees to 180 degrees, or 90 degrees, 95 degrees, 105 degrees, 120 degrees, 135 degrees, 150 degrees, 165 degrees, 175 degrees, 180 degrees or the combination thereof.

In one embodiment, the swinging board 142 is hinged in the body 120 with the hinge 148, but not limited to this. The swinging board 142 may use a flexible connecting portion (not shown), made of an elastic material or a rubber material, to connect to the body 120 so that the swinging board 142 can move between the operating position 126 and the reserving position 128 with respect to the reserving chamber 124.

When the user can operate the notebook computer without the foregoing connectors, the user can rotate the swinging board 142 to the reserving chamber 124 of the lower cover 122 of the body 120 to the reserving position 128 so that the connectors and the swinging board 142 can be effectively stored in the reserving chamber 124 of the lower cover 122 of the body 120 of the notebook computer without influence on the thickness of the notebook computer.

With reference to FIG. 6, the first connector 144 includes a length 602, a height 604 and a thickness 606. If the length 602 or the height 604 of the first connector 144 is greater than the thickness 606 thereof, the first connector 144 is suitable to be disposed on the swinging board 142 according to the present invention. Preferably, the thickness 606 of the first connector 144 is smaller than the length 602 and the height 604 thereof. When the thickness 606 of the first connector 144 is smaller than only one of the length 602 and the height 604 of the first connector 144, the first connector 144 disposed on the swinging board 142 can effectively be stored in the lower cover 122 of the body 120 to save the area requirement on the sidewall of the notebook computer. When the thickness 606 of the first connector 144 is smaller than the length 602 and the height 604, not only the area requirement on the sidewall can be effectively saved but also the thickness limitation of the notebook computer is also reduced. That is to say, the thickness limitation of the notebook computer is relative to the thickness 606 of the first connector 144, and without relation to the length 602 and the height 604 of the first connector 144.

Similarly, the second connector 146 includes a length 612, a height 614 and a thickness 616. If the length 612 or the height 614 of the second connector 146 is greater than the thickness 616 thereof, the second connector 146 is suitable to be disposed on the swinging board 142 according to the present invention. Preferably, the thickness 616 of the second connector 146 is smaller than the length 612 and the height 614 thereof. When the thickness 616 of the second connector 146 is smaller than only one of the length 612 and the height 614 of the second connector 146, the second connector 146 disposed on the swinging board 142 can effectively be stored in the lower cover 122 of the body 120 to save the area requirement on the sidewall of the notebook computer. When the thickness 616 of the second connector 146 is smaller than the length 612 and the height 614, not only the area requirement on the sidewall can be effectively saved but also the thickness limitation of the notebook computer is also reduced. That is to say, the thickness limitation of the notebook computer is relative to the thickness 616 of the second connector 146, and without relation to the length 612 and the height 614 of the second connector 146. In addition, the height of the swinging board 142 is preferably greater than the thickness of the first connector 144, the second connector 146 and the swinging board 142.

Hence, the swinging board 142 according to the present invention can effectively increase the area for disposing the connectors of the electronic device, especially for the notebook computer, and reduce the thickness limitation of the electronic device due to the connectors. In addition, the swinging board 142 further includes a cable 620, a circuit board 630, a first connector 144 and a second connector 146. The circuit board 630 could be a motherboard or a board connected to a motherboard. In this embodiment, the first connector 144 and the second connector 146 are disposed on the circuit board 630, and electrically connect to a motherboard (not shown) in the body 120 through the circuit board 630 and the cable 620. Since the first connector 144 and the second connector 146 are disposed perpendicular to the swinging board 142, the first connector 144 and the second connector 146 can still connect to the external electronic devices through the first cable 210 and the second cable 220 even when the swinging board 142 is stored in the lower cover 122 of the body 120 as long as the notebook computer is raised by a support or an opening is formed on a support which is disposed under the notebook computer.

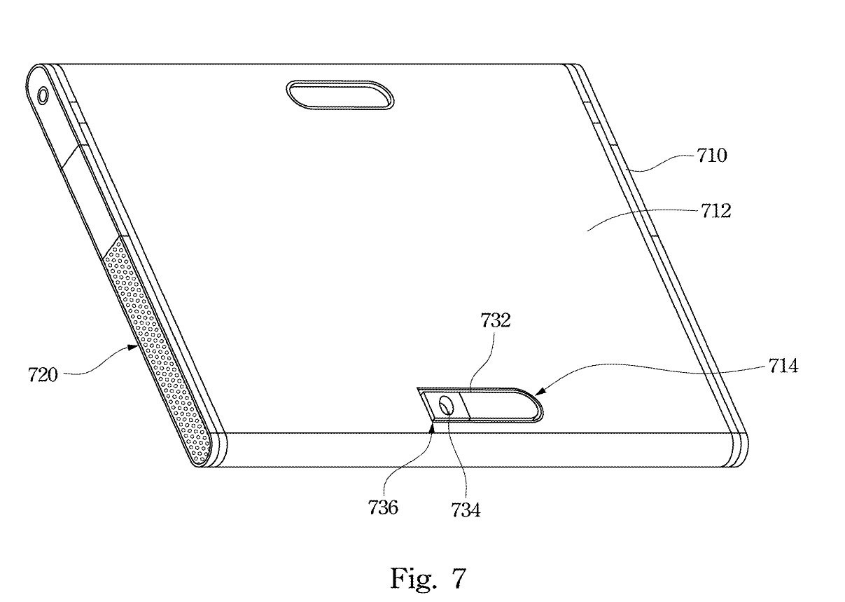

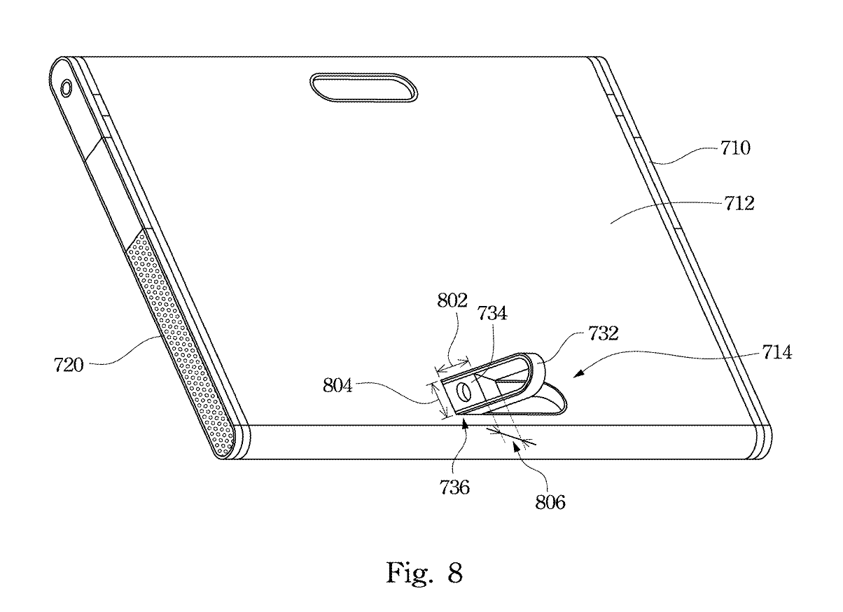

With reference to FIG. 7, another embodiment of the electronic device, e.g. electronic book, tablet personal computer, and netpad, with the swinging board according to the present invention is illustrated. FIG. 8 illustrates the swinging board is opened from the electronic device to form a foot for the electronic device. A swinging board 732 is disposed on the reserving chamber 714 of the lower cover 712 of the body 710, and a display panel 720 is disposed on the other side of the lower cover 712. The swinging board 732 further includes a connector 734 and a hinge 736. When the swinging board 732 is moved to an operating position, preferably rotated to the operating position, the swinging board 732 converts into a foot of the electronic book, the tablet personal computer, or the netpad to allow the user conveniently operating and reading on the electronic book, the tablet personal computer, or the netpad.

When the swinging board 732 is moved to a reserving position (see FIG. 7), the connector 734 on the swinging board 732 is stored in the reserving chamber 714. Similarly, the connector 734 includes a length 802, a height 804 and a thickness 806. If the length 802 or the height 804 of the connector 734 is greater than the thickness 806 thereof, the connector 734 is suitable to be disposed on the swinging board 732 according to the present invention. Preferably, the thickness 806 of the connector 734 is smaller than the length 802 and the height 804 thereof. Hence, the thickness limitation of the electronic book, the tablet personal computer, or the netpad is only relative to the thickness 806 of the connector 734, and without worry about the length 802 and the height 804 of the connector 734. In addition, the area requirement on the sidewall can be effectively saved.

Accordingly, the electronic device with the swinging board according to the present invention can effectively increase the area for disposing the connectors of the electronic device, and reduce the thickness limitation of the electronic device. Hence, the electronic device is getting lighter, thinner and smaller so as to increase the portability of the electronic device.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. An electronic device with a swinging board, comprising:
a body having a circuit board and a reserving chamber;
a swinging board having an opening, the swinging board connected to the body and movable between an operating position and a reserving position with respect to the reserving chamber; and
a connector disposed in the opening and electrically connected to the circuit board, wherein the connector is stored in the reserving chamber when the swinging board is rotated to the reserving position, and the connector is moved to an outside of the reserving chamber when the swinging board is rotated to the operating position.

2. The electronic device with the swinging board of claim 1, wherein a rotating angle of the swinging board between the reserving position and the operating position is greater than 90 degrees.

3. The electronic device with the swinging board of claim 1, wherein the connector is a RJ-45 connector, a VGA connector or a power connector.

4. The electronic device with the swinging board of claim 1, wherein a thickness of the connector is smaller than a length of the connector.

5. The electronic device with the swinging board of claim 1, wherein a thickness of the connector is smaller than a height of the connector.

6. The electronic device with the swinging board of claim 1, wherein the electronic device is a notebook computer, an electronic book, a tablet personal computer, or a netpad.

7. The electronic device with the swinging board of claim 1, wherein the swinging board is connected to the body with a hinge or a flexible connecting portion.

8. The electronic device with the swinging board of claim 1, wherein the circuit board is a motherboard or a board connected to the motherboard.
